(19) United States
(12) Patent Application Publication
(10) Pub. No.: US 2025/0020513 A1
(43) Pub. Date: Jan. 16, 2025

(54) PHOTOMETRIC APPARATUS AND PHOTOMETRIC METHOD

(71) Applicant: Konica Minolta, Inc., Tokyo (JP)

(72) Inventor: Katsutoshi TSURUTANI, Hirano-ku (JP)

(21) Appl. No.: 18/762,221

(22) Filed: Jul. 2, 2024

(30) Foreign Application Priority Data
Jul. 10, 2023 (JP) 2023-113011

(51) Int. Cl. G01J 3/50; G01J 3/02; G01J 3/51

(52) U.S. Cl. CPC G01J 3/506; G01J 3/0208; G01J 3/0218; G01J 3/51

(57) ABSTRACT

A photometric apparatus includes: a splitting optical system that splits light to be measured from an object to be measured into a plurality of light rays; a colorimetric optical system having a wavelength-selective filter on which the light that is to be measured and has been split by the splitting optical system is incident, and a light receiving sensor that receives the light that is to be measured and has been transmitted through the wavelength-selective filter; and a light attenuation member that is insertable in and removable from a light path of the light to be measured, in which the light attenuation member is disposed in front of the splitting optical system.

### CROSS-REFERENCE TO RELATED APPLICATION

The disclosure of Japanese Patent Application No. 2023-113011 filed on Jul. 10, 2023, including description, claims, drawings, and abstract, is incorporated herein by reference in its entirety.

### BACKGROUND OF THE INVENTION

### 1. Technical Field

The present invention relates to a photometric apparatus and a photometric method capable of measuring luminance, chromaticity, and the like of light emitted from an object to be measured such as a display of a smartphone or a liquid crystal monitor.

### 2. Description of Related Art

As a photometric apparatus as described above, as illustrated in FIG. 24, there is known a photometric apparatus 100 provided with a splitting optical system 120 for splitting light 201 to be measured from an object 200 to be measured into a plurality of light rays (for example, Japanese Patent No. 5454675).

The photometric apparatus 100 includes an objective optical system 110 formed of a convex lens or the like, the splitting optical system 120, and colorimetric optical systems 130 to 150. As an example, a bundle fiber is used for the splitting optical system 120. The bundle fiber is formed by bundling a plurality of strand fibers having a small diameter. On the emission end (exit) side of the bundle fiber, the plurality of strand fibers are randomly branched into a plurality of pieces, and the plurality of pieces are bundled in groups of the pieces. The number of branches is, for example, three corresponding to tristimulus values of color-matching functions X, Y, and Z defined by the Commission Internationale de l'Eclairage (CIE). Furthermore, a diffuser plate may be used as the splitting optical system 120.

As the colorimetric optical systems 130 to 150, for example, wavelength-selective filters and light receiving sensors are used in combination in the same number as the number of branches of the splitting optical system 120.

Light received by the light receiving sensors is converted into electrical signals, electrical processing sections 161a to 161c perform processing such as I/V conversion and amplification on the electrical signals, and the electrical signals are input to a controller 162 as received light data. The controller 162 performs calculation based on the input received light data to calculate a measured value.

In recent years, displays having a wide luminance dynamic range have been used in smartphones and the like. Therefore, the photometric apparatus is required to have capability to measure luminance from low luminance to high luminance in performing gamma inspection, adjustment, or the like.

In order to widen the dynamic range of the photometric apparatus 100, it is necessary to control the amount of received light due to constraints on the photoelectric conversion capability of the light receiving sensors (saturation of the light receiving sensors) and the design conditions of the electrical processing sections 161a to 161c. Therefore, it is conceivable to insert or remove, in accordance with the brightness of the object 200 to be measured, a light attenuation member into or from the light path of the light 201 that is to be measured and has been emitted from the object 200 to be measured and will enter the light receiving sensors.

However, it has been found by the research of the inventors that, depending on the insertion and removal position of the light attenuation member in the light path, multiple reflection occurs on the light attenuation member and other constituent members of the photometric apparatus 100, for example, the wavelength-selective filters and the light receiving sensors of the colorimetric optical systems 130 to 150. In addition, it has been found by the research of the inventors that the received light spectral sensitivity of the colorimetric optical systems 130 to 150 changes due to the multiple reflection and a measurement error increases.

### SUMMARY OF THE INVENTION

An object of the present invention is to provide a photometric apparatus and a photometric method capable of suppressing an increase in a measurement error while achieving an increase in a dynamic range by inserting and removing a light attenuation member into and from a light path of light to be measured.

A first aspect of the present invention relates to
a photometric apparatus including:
a splitting optical system that splits light to be measured from an object to be measured into a plurality of light rays;
a colorimetric optical system having a wavelength-selective filter on which the light that is to be measured and has been split by the splitting optical system is incident, and a light receiving sensor that receives the light that is to be measured and has been transmitted through the wavelength-selective filter; and
a light attenuation member that is insertable in and removable from a light path of the light to be measured, wherein
the light attenuation member is disposed in front of the splitting optical system.

A second aspect of the present invention relates to
a photometric method including:
inserting and removing a light attenuation member into and from a light path of light to be measured at a position in front of a splitting optical system in a photometric apparatus including
the splitting optical system that splits the light to be measured from an object to be measured into a plurality of light rays, and
a colorimetric optical system having a wavelength-selective filter on which the light that is to be measured and has been split by the splitting optical system is incident, and a light receiving sensor that receives the light that is to be measured and has been transmitted through the wavelength-selective filter.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a block diagram illustrating an internal configuration of a photometric apparatus according to a first embodiment of the present invention;

FIG. 2 is an explanatory diagram of a light attenuation member in which a thin film filter is used;

FIG. 3 is a graph illustrating an example of the actual transmittance of a glass absorption filter and a thin film filter for each wavelength, both of the glass absorption filter and the thin film filter having a transmittance T≈5%;

FIG. 4 is a graph illustrating the transmittance of the glass absorption filter and the thin film filter for each wavelength when each of the glass absorption filter and the thin film filter is combined with a Y filter as a wavelength-selective filter in comparison with a color-matching function Y;

FIG. 5 is a graph illustrating an example of reflection characteristics of a silicon sensor used as light receiving sensors;

FIG. 6A is a schematic diagram for explaining a state of reflection of light incident on an interference film filter used as a wavelength-selective filter;

FIG. 6B is a graph of the transmittance and reflectance of the interference film filter;

FIGS. 7A and 7B are graphs illustrating examples of the transmittance and reflectance of a light attenuation member in a visible light range (wavelengths of 380 to 780 nm), respectively, the light attenuation member being formed of a thin film filter in which a thin film is a metallic oxide film of niobium oxide;

FIG. 8 is a configuration diagram of the photometric apparatus in a case where the insertion and removal position of the light attenuation member is between wavelength-selective filters and the light receiving sensors;

FIG. 9 is a schematic explanatory diagram illustrating that multiple reflection occurs on the light attenuation member and the wavelength-selective filters and occurs on the light attenuation member and the light receiving sensors in the configuration illustrated in FIG. 8;

FIG. 10A is a diagram illustrating the transmission and reflection of the light that is to be measured and has a wavelength of approximately 500 nm when the Y filter is taken as an example;

FIG. 10B is a diagram illustrating the transmission and reflection of the light to be measured in a state in which the light attenuation member is inserted behind the Y filter;

FIGS. 11A1 to 11B3 are graphs in a case where the effect of multiple reflection off the light attenuation member and the wavelength-selective filters in a state in which the light attenuation member is inserted behind the wavelength-selective filters is considered;

FIG. 12 is a diagram illustrating a state of transmission, reflection, and reception of the light to be measured in a state in which the light attenuation member is inserted in front of the light receiving sensors;

FIGS. 13A1 to 13B3 are graphs in a case where the effect of multiple reflection off the light attenuation member and the wavelength-selective filters and multiple reflection off the light attenuation member and the light receiving sensors in a state in which the light attenuation member is inserted behind the wavelength-selective filters is considered;

FIG. 14 is a configuration diagram of the photometric apparatus in a case where the insertion and removal position of the light attenuation member is in front of the wavelength-selective filters;

FIG. 15 is a schematic explanatory diagram illustrating that multiple reflection occurs on the light attenuation member and the wavelength-selective filters and occurs on the light attenuation member and the light receiving sensors in the configuration illustrated in FIG. 14;

FIG. 16 is a schematic explanatory diagram for explaining the reason why the effect of multiple reflection becomes small in the configuration according to the first embodiment;

FIG. 17 is a block diagram illustrating an internal configuration of a photometric apparatus according to a second embodiment of the present invention;

FIG. 18A and FIG. 18B are diagrams for explaining a light mixing effect of an optical fiber;

FIG. 19A and FIG. 19B are diagrams for explaining the light mixing effect of the optical fiber;

FIG. 20 is a block diagram illustrating an internal configuration of a photometric apparatus according to a third embodiment of the present invention;

FIG. 21 is a block diagram illustrating an internal configuration of a photometric apparatus according to a fourth embodiment of the present invention;

FIG. 22 is a block diagram illustrating an internal configuration of a photometric apparatus according to a fifth embodiment of the present invention;

FIG. 23 is a flowchart for explaining a method of controlling insertion and removal of a light attenuation member in each photometric apparatus according to the present embodiment; and

FIG. 24 is a block diagram illustrating a general configuration of a photometric apparatus.

### DETAILED DESCRIPTION

Hereinafter, one or more embodiments of the present invention will be described with reference to the drawings. However, the scope of the invention is not limited to the disclosed embodiments.

Hereinafter, embodiments of the present invention will be described with reference to the drawings.

### First Embodiment

### <Overall Configuration>

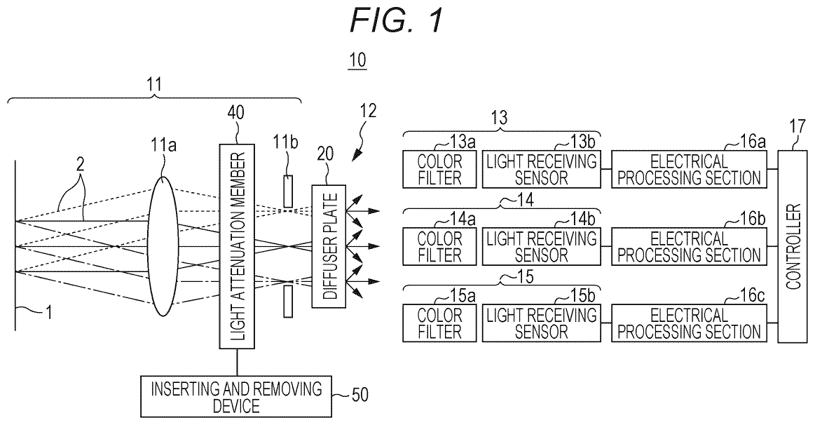

FIG. 1 is a block diagram illustrating a configuration of a tristimulus value type photometric apparatus according to a first embodiment of the present invention.

In FIG. 1, the photometric apparatus 10 is used, for example, in an inspection process for a manufacturing line of a display of a smartphone, and measures brightness, chromaticity, and the like of a display surface of a display which is an object 1 to be measured.

The photometric apparatus 10 includes an objective optical system 11, a splitting optical system 12, colorimetric optical systems 13 to 15, and a light attenuation member 40. A convex lens 11a having positive power is used in the objective optical system 11. A diffuser plate 20 having functions of splitting and diffusing is used in the splitting optical system 12.

An aperture diaphragm 11b is arranged at a rear-side focal position of the convex lens 11a, and a front-side telecentric optical arrangement is formed in order to take in components within a predetermined angle (for example, ±2.5 degrees) with respect to a normal line of a surface to be measured which is the display surface of the object 1 to be measured. The diffuser plate 20 is disposed behind a surface of the aperture diaphragm 11b.

The light attenuation member 40 is disposed between the convex lens 11a and the diffuser plate 20 and in front of a surface of the aperture diaphragm 11b. The light attenuation member 40 is driven by an inserting and removing device 50 so as to be inserted into or removed from a light path of light 2 to be measured. The inserting and removing device 50 is a driving device The inserting and removing device 50 includes, for example, a linear actuator. In a state in which the light attenuation member 40 is inserted in the light path of the light 2 to be measured, the amount of the light 2 to be incident on the diffuser plate 20 and to be measured is reduced by the light attenuation member 40. In a state in which the light attenuation member 40 is removed from the light path of the light 2 to be measured, the light 2 to be measured is incident on the diffuser plate 20 without a decrease in the amount of the light 2 to be measured.

The light attenuation member 40 is inserted in and removed from the light path in accordance with the brightness of the object 1 to be measured. To be more specific, the light attenuation member 40 is in a removed state when the object 1 to be measured is dark, and is inserted in the light path when the object 1 to be measured is bright, thereby preventing saturation of light receiving sensors 13b, 14b, and 15b by reducing the amount of the light. Thus, the intensity of the light 2 to be measured can be within a dynamic range of the light receiving sensors 13b, 14b, and 15b, and as a result, the dynamic range of the photometric apparatus 10 is expanded. In the following description, the light attenuation member is also referred to as an ND filter.

It is desirable that the light attenuation member 40 be arranged close to the light collecting position (the position of the aperture diaphragm 11b) of the objective optical system 11. In the light path of the light 2 to be received and measured, an effective light path at the position of the aperture diaphragm is short. As the effective optical path is smaller, the size of the material of the optical attenuator 40 may be smaller, the insertion and extraction device 50 may be smaller, and the driving torque may be lower. Therefore, the product becomes compact, the weight becomes light, and the cost becomes low. The aperture diaphragm 11b may not be provided.

The type of the light attenuation member 40 is not limited, and various types such as a thin film filter, a glass absorption filter, and a porous plate can be used as the light attenuation member 40. However, it is important that the light attenuation member 40 has spectral flatness (uniformity). This is because the flatness affects the spectral responsivity in the inserted or removed state of the light attenuation member 40 (with or without the light attenuation member 40). In a case where the light attenuation member 40 is not flat, the received light spectral sensitivity when the light attenuation member 40 is absent (removed from the light path) and the received light spectral sensitivity when the light attenuation member 40 is present (inserted in the light path) change. When the received light spectral sensitivity deviates from color-matching functions, an error occurs in luminance and chromaticity. It is also important that there is no change due to environmental temperature or the like.

The glass absorption filter is inferior in spectral flatness and the transmittance of the glass absorption filter largely changes due to environmental temperature. Although the porous plate has spectral flatness, a measured acceptance angle may vary. In addition, strict position repeatability is required. The thin film filter has good spectral flatness and high reliability with respect to environmental temperature. Therefore, the thin film filter is preferably used as the light attenuation member 40.

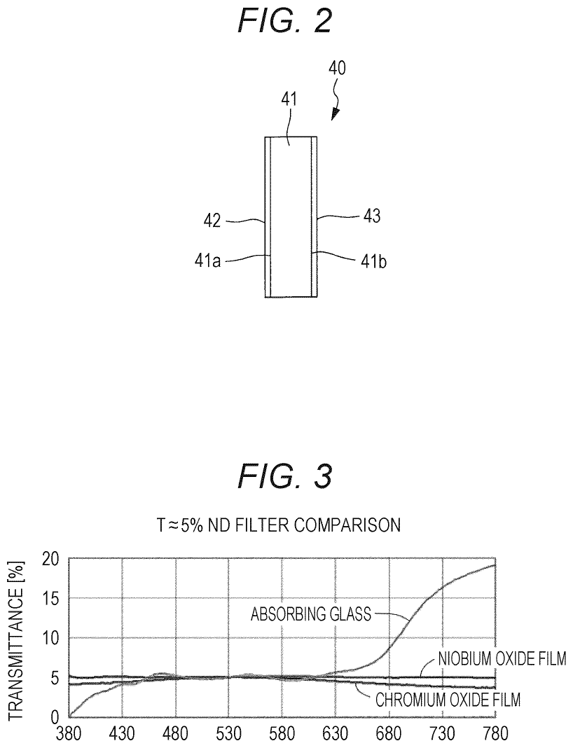

FIG. 2 illustrates an example of the light attenuation member 40 in which a thin film filter is used.

With reference to FIG. 2, the light attenuation member 40 includes thin films 42 and 43 and a transparent substrate 41 supporting the thin films 42 and 43. The transparent substrate 41 is formed of an optical material that is transparent to the light 2 to be measured, such as glass, plastic, quartz, or sapphire, for example. The transparent optical material forming the transparent substrate 41 can be appropriately selected in accordance with the wavelength range of the light 2 to be measured.

Each of the thin films 42 and 43 is formed on at least one of an incident surface 41a and an emission surface 41b of the transparent substrate 41. Specifically, the light attenuation member 40 includes at least one of the thin films 42 and 43. The thin film 42 is formed on the incident surface 41a of the transparent substrate 41. The thin film 43 is formed on the emission surface 41b of the transparent substrate 41. Specifically, the thin films 42 and 43 are formed on both the incident surface 41a and the emission surface side 41b of the transparent substrate 41.

To be specific, the light attenuation member 40 includes the thin film 42 formed on the incident surface 41a of the transparent substrate 41 and the thin film 43 formed on the emission surface 41b of the transparent substrate 41. The thin films 42 and 43 may have the same film structure or different film structures. The thin films 42 and 43 may be formed of the same material or different materials. Each of the thin films 42 and 43 may be, for example, an interference film formed of a dielectric material such as SiO₂ or MgF₂, or may be a metal-oxide film formed of a metal-oxide material such as Al₂O₃, TiO₂, Nb₂O₅, or NbO. Alternatively, a metal material such as Cr or Nb may be used as the material of the thin films 42 and 43.

An absorption type light attenuation member that absorbs light inside a substrate (e.g., a glass substrate) is known as the light attenuation member 40. The degree of freedom in designing the transmission spectrum of the absorption type light attenuation member is relatively low. In addition, the stability of the absorption type light attenuation member with respect to environment temperature and environment humidity is relatively low. On the other hand, the degree of freedom in designing the transmission spectrum of the interference type light attenuation member (for example, the light attenuation member 40 including the thin films 42 and 43 which are the interference films) is relatively high. In addition, the stability of the interference type light attenuation member with respect to environmental temperature and environmental humidity is relatively high.

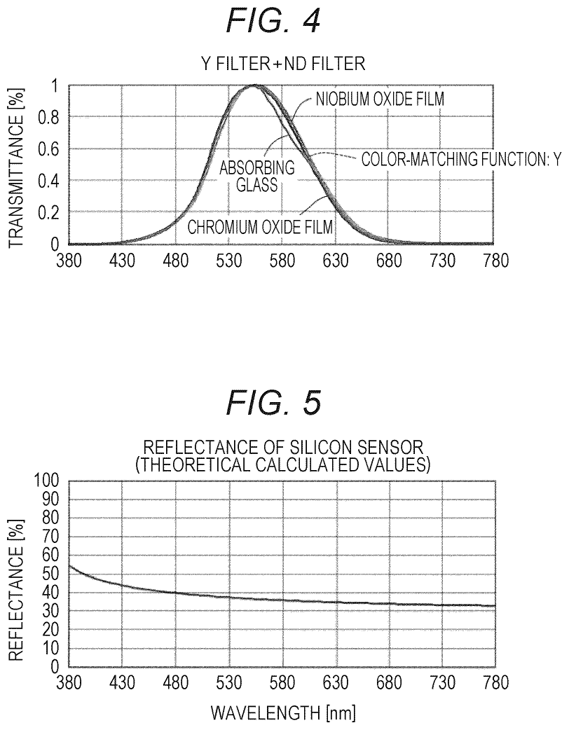

FIG. 3 illustrates the actual transmittance of the glass absorption filter and the actual transmittance of the thin film filter for each wavelength in a visible light range (wavelengths of 380 to 780 nm) for reference. In all cases, the average transmittance is T≈5%. FIG. 4 illustrates the transmittance of the glass absorption filter and the transmittance of the thin film filter for each wavelength when each of the glass absorption filter and the thin film filter is combined with a Y filter 14a among color filters 13a, 14a, and 15a in comparison with the color-matching function Y. In the thin film filter illustrated in FIG. 3 and FIG. 4, a niobium oxide film and a chromium oxide film are used as thin films.

As illustrated in FIG. 3, it is found that the thin film filter has better spectral flatness than the glass absorption filter. Further, as illustrated in FIG. 4, in the case of the glass absorption filter, a deviation from the color-matching functions occurs, but in the case of the thin film filter, a deviation hardly occurs.

The colorimetric optical systems 13, 14, and 15 include wavelength-selective filters 13a, 14a, and 15a, which are color-matching function filters corresponding to the tristimulus values of X, Y, and Z, and light receiving sensors 13b, 14b, and 15b used in combination with the wavelength-selective filters 13a, 14a, and 15a, respectively. In the following description, the wavelength-selective filters are also referred to as color filters.

The color filters 13a, 14a, and 15a may be formed by laminating a plurality of light absorption type filters such that the color filters 13a, 14a, and 15a have transmittances corresponding to desired spectral characteristics, such as the tristimulus values of X, Y, and Z, for incident light. However, in such a configuration, there is a problem that a filter having transmittance peaks in two wavelength regions cannot be designed, that is, the degree of freedom of filter design is low. In addition, each of the light absorption type filters also has a problem in that the transmittance is low and a light amount loss is large. Furthermore, particularly in the case of a film-shaped color filter, there is a problem in that the color filter changes rapidly over time (has poor stability) with respect to heat, light (ultraviolet rays), humidity, and the like.

Therefore, it is desirable to use interference type filters (hereinafter referred to as interference film filters) for the color filters 13a, 14a, and 15a, instead of the light absorption type filters. Each of the interference film filters is formed by laminating several tens of layers of dielectrics or oxides on a glass substrate by a method such as vacuum deposition or sputtering, and is a filter for selecting a wavelength for transmission or reflection by an interference action of light.

Therefore, the interference film filter is easy to obtain a desired transmittance (that is, easy to design and has a high degree of freedom in design) as compared with the above-described light absorption type filter, and a filter having two peaks (mountains) like the color-matching function X can be formed. In addition, since the interference film filter has a high transmittance, for example, the peak transmittance of the interference film filter is close to 100% while the peak transmittance of the light absorption type filter is 50% or less. Furthermore, the interference film filter has an advantage of excellent reliability, that is, has a less change in transmittance over time due to temperature, humidity, and exposure to light.

In the present embodiment, silicon sensors are used as the light receiving sensors 13b, 14b, and 15b.

Light received by the light receiving sensors 13b, 14b, and 15b is converted into electrical signals, the electrical signals are subjected to processing such as I/V conversion and amplification in corresponding electrical processing sections 16a, 16b, and 16c, and are then input as received light data to a controller 17. The controller 17 performs calculation based on the input received light data to calculate a measured value.

Incidentally, when the light 2 to be measured reaches the color filters 13a, 14a, and 15a of the colorimetric optical system 13, the light 2 to be measured passes through the color filters 13a, 14a, and 15a, but a part of the light 2 to be measured is reflected off the surfaces of the color filters 13a, 14a, and 15a. A part of the reflected light returns to the light attenuation member 40 and is reflected again off the surface of the light attenuation member 40, and the light reflected again repeatedly passes through and is reflected off the color filters 13a, 14a, and 15a. In this way, the multiple reflection off the color filters 13a, 14a, and 15a and the light attenuation member 40 is repeated.

On the other hand, the light 2 to be measured that has passed through the color filters 13a, 14a, and 15a and reached the light receiving sensors 13b, 14b, and 15b is received by the light receiving sensors 13b, 14b, and 15b, but a part of the light 2 to be measured is reflected off the surfaces of the light receiving sensors 13b, 14b, and 15b. A part of the reflected light passes through the color filters 13a, 14a, and 15a, returns to the light attenuation member 40, is reflected again off the surface of the light attenuation member 40, and is repeatedly received by and reflected off the light receiving sensors 13b, 14b, and 15b. In this way, the multiple reflection off the light receiving sensors 13b, 14b, and 15b and the light attenuation member 40 is repeated.

The inventor has found that the behavior of the multiple reflection that occurs on the light attenuation member 40 and the color filters 13a, 14a, and 15a and occurs on the light attenuation member 40 and the light receiving sensors 13b, 14b, and 15b greatly varies depending on the insertion and removal position of the light attenuation member 40. The inventor has further found that it is possible to reduce the effect of the multiple reflection on measured values by inserting and removing the light attenuation member at a position in front of the splitting optical system 12.

FIG. 5 illustrates an example of reflection characteristics of a silicon sensor used as the light receiving sensors 13b, 14b, and 15b.

Generally, approximately ⅓ of the input optical energy is converted into electricity in the silicon sensor, and the converted electricity is transmitted to the electrical processing units 16a, 16b, and 16c and the controller 17. Approximately ⅓ of the input light energy is converted to heat and escapes into the atmosphere. Approximately ⅓ of the input light energy is reflected. As illustrated in FIG. 5, the reflectance of the silicon sensor is in a range of 30% to 40% depending on the wavelength region of the light to be measured.

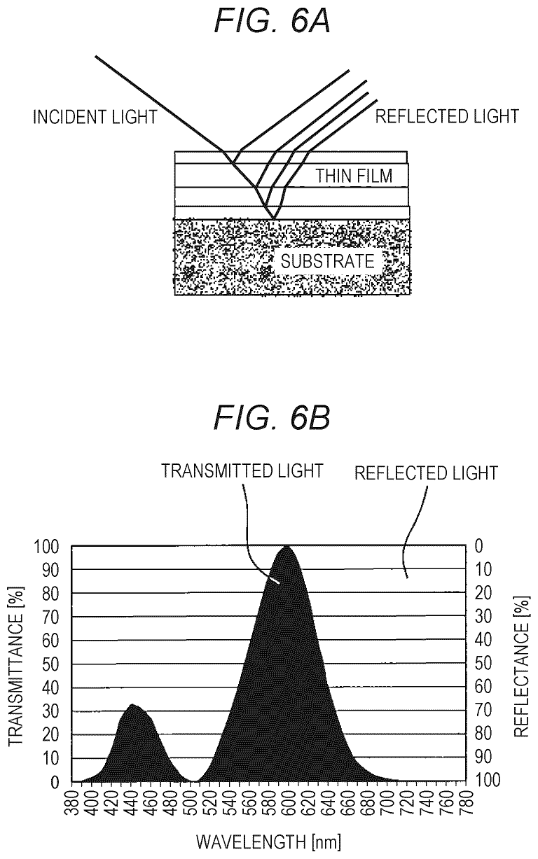

In the interference film filters used as the color filters 13a, 14a, and 15a, the film material (dielectrics) absorbs little light. As illustrated in FIG. 6A, incident light (light to be measured) other than transmitted light is reflected off each layer and becomes reflected light.

FIG. 6B illustrates a graph of the transmittance and reflectance of the interference film filter as the X filter. In FIG. 3B, a black portion inside a characteristic curve of the transmittance with respect to a wavelength corresponds to transmitted light, a white portion outside the characteristic curve corresponds to reflected light, and the transmittance+the reflectance≈100%.

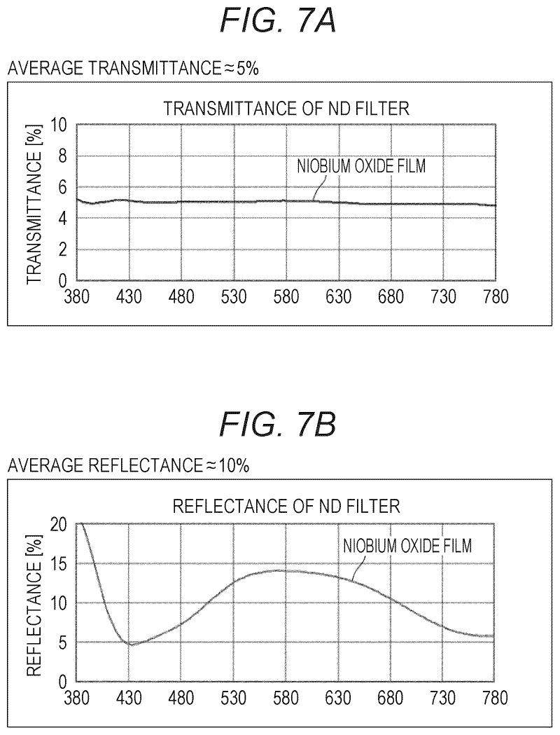

FIGS. 7A and 7B each illustrate an example of the transmittance and reflectance of a light attenuation member (denoted as an ND filter in FIG. 7A) formed of a thin film filter in which the thin film is a metallic oxide film of niobium oxide in a visible light range (wavelengths 380 to 780 nm). The average transmittance≈5% and the average reflectance≈10%.

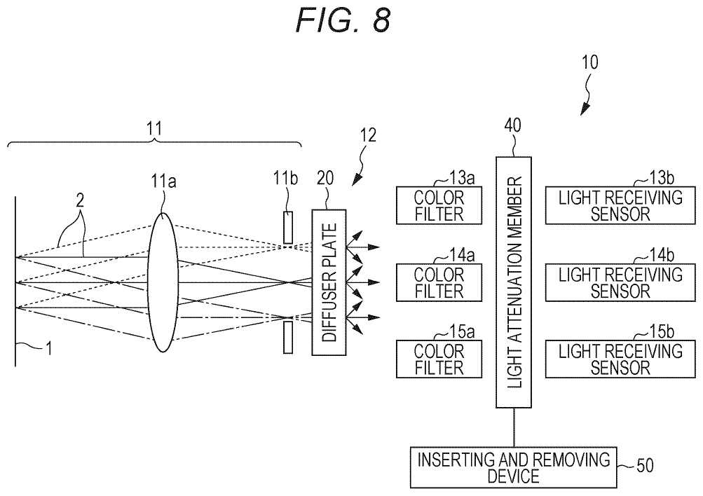

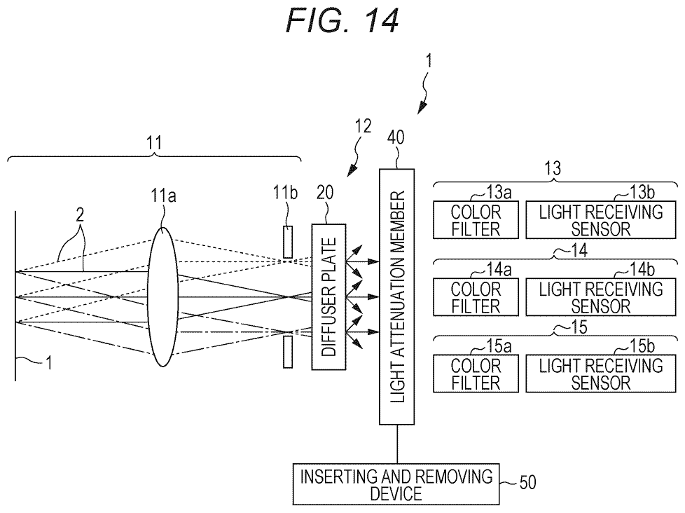

Next, the reason why the effect of multiple reflection on the measured values can be reduced by the light attenuation member 40 being inserted and removed at a position in front of the splitting optical system 12 will be described. This description will be provided in comparison with the case where the insertion and removal position of the light attenuation member 40 is between the color filters 13a, 14a, and 15a and the light receiving sensors 13b, 14b, and 15b (see FIG. 8) and the case where the insertion and removal position of the light attenuation member 40 is between the color filters 13a, 14a, and 15a and the diffuser plate 20 (see FIG. 14).

<In Case where Insertion and Removal Position of Light Attenuation Member 40 is Between Color Filters 13a 14a, and 15a and Light Receiving Sensors 13b 14b, and 15b>

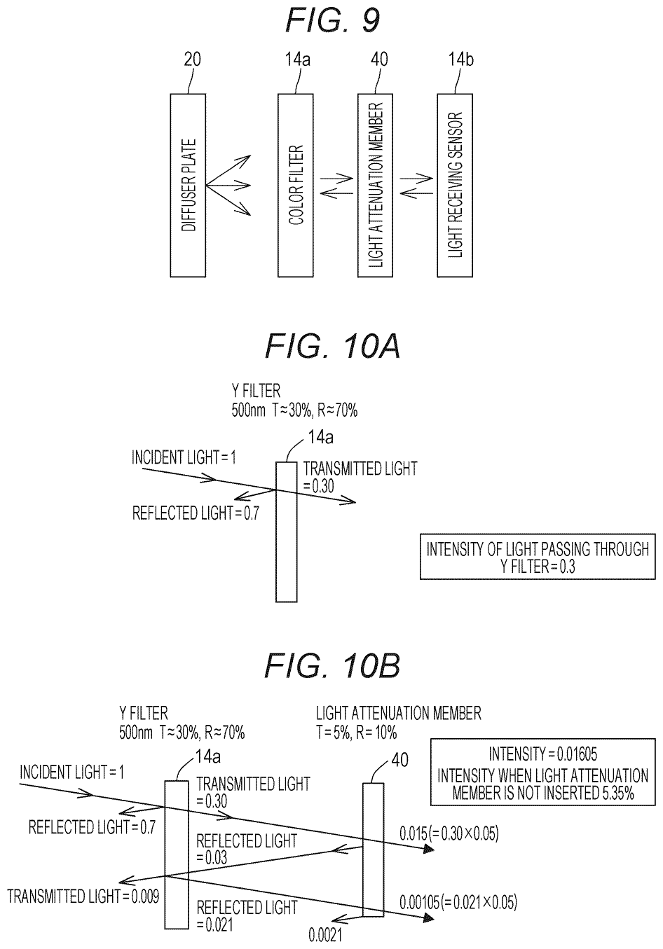

In this case, as schematically illustrated in FIG. 9, multiple reflection occurs on the light attenuation member 40 and the color filters 13a, 14a, and 15a. In addition, multiple reflection also occurs on the light attenuation member 40 and the light receiving sensors 13b, 14b, and 15b. Although FIG. 9 representatively illustrates the color filter 14a and the light receiving sensor 14b, the same applies to the other color filters 13a and 15a and the other light receiving sensors 13b and 15b.

### (1) Multiple Reflection Off the Light Attenuation Member 40 and the Color Filters 13a, 14a, and 15a Will be Described Below.

FIG. 10A illustrates the states of transmission and reflection of the light 2 that is to be measured and has a wavelength of approximately 500 nm, taking the color filter 14a, which is a Y filter, as an example. It is assumed that the transmittance T and the reflectance R of the Y filter 14a are T≈30% and R≈70%, respectively. When the intensity of the incident light is 1, the intensity of the transmitted light is 0.30 and the intensity of the reflected light is 0.70.

Next, as illustrated in FIG. 10B, a state in which the light attenuation member 40 is inserted behind the Y filter 14a is considered. It is assumed that the transmittance T and the reflectance R of the light attenuation member 40 are T=5% and R=10%, respectively.

When the transmitted light that has an intensity of 0.3 and has been transmitted through the Y filter 14a is transmitted through the light attenuation member 40, the intensity of the transmitted light becomes 0.015 (=0.30×0.05). On the other hand, the intensity of the light reflected off the light attenuation member 40 is 0.03 (=0.30×0.40).

The reflected light that has an intensity of 0.03 and has been reflected off the light attenuation member 40 returns to the Y filter 14a, but is reflected again off the Y filter 14a to become reflected light having an intensity of 0.021 (=0.03×0.7) and travels to the light attenuation member 40.

The reflected light having an intensity of 0.021 is transmitted through the light attenuation member 40. The intensity of the transmitted light is 0.00105 (=0.021×0.05). Note that although a part of the reflected light having an intensity of 0.021 is reflected off the light attenuation member 40, subsequent multiple reflection is ignored.

Due to the behavior of the light 2 to be measured described above, the total intensity of the light 2 that is to be measured and has been transmitted through the light attenuation member 40 is 0.01605 (=0.015+0.00105).

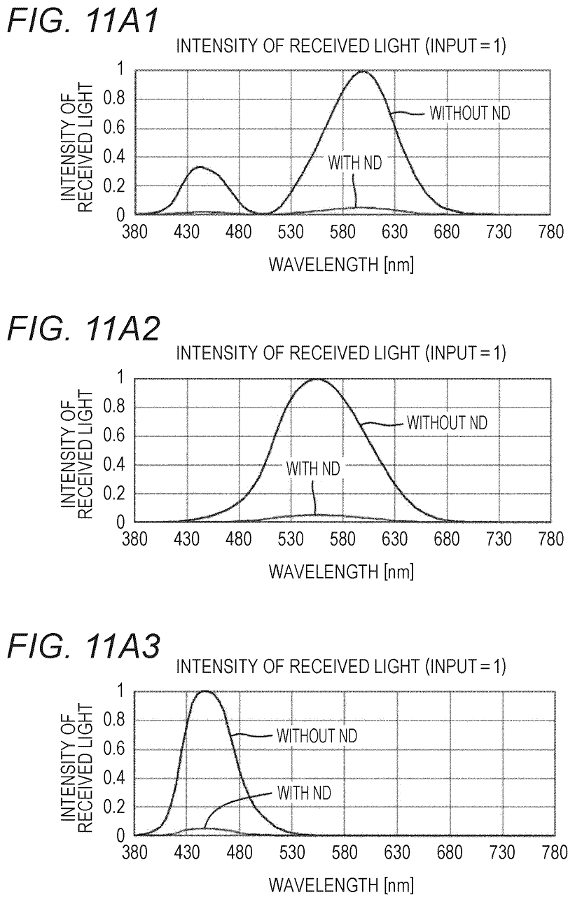

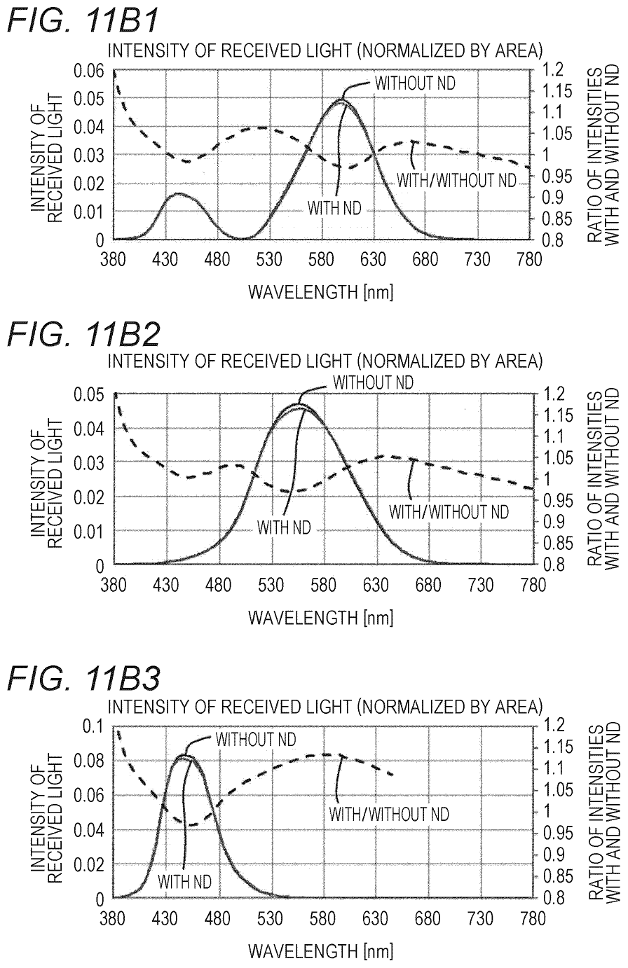

Next, the same calculation was performed for each of the X filter 13a, the Y filter 14a, and the Z filter 15a in the range of wavelengths from 380 nm to 780 nm in the state in which the light attenuation member 40 was inserted in the light path and in the state in which the light attenuation member 40 was removed from the light path. The results of the calculation are illustrated in FIGS. 11A1 to 11A3.

Each of curves indicated by “without ND” indicates the intensity of received light in the state in which the light attenuation member 40 is removed from the light path. The intensity of the received light is the intensity of light which is the light 2 that is to be measured, has an intensity 1, and is input to each of the color filters 13a to 15a and transmitted through each of the color filters 13a to 15a. Each of curves indicated by “with ND” indicates the intensity of received light in the state in which the light attenuation member 40 is inserted in the light path. The intensity of the received light is the intensity of the light (including light transmitted again by reflection) which is the light 2 that is to be measured and has the intensity 1 is input to each of the color filters 13a to 15a and transmitted through the light attenuation member 40.

FIGS. 11B1 to 11B3 are graphs in which the characteristics illustrated in FIGS. 11A1 to 11A3 are normalized by areas in order to make the evaluation criteria the same. In each of the graphs, there is a slight difference in intensity of received light between “with ND” and “without ND”, that is, between the state in which the light attenuation member 40 is inserted in the light path and the state in which the light attenuation member 40 is not inserted in the light path.

In order to clarify the difference in intensity of received light between the state in which the light attenuation member 40 is inserted in the light path and the state in which the light attenuation member 40 is not inserted in the light path, results of calculating the ratios of the intensities of received light indicated by “with ND” to the intensities of received light indicated by “without ND” are indicated by broken lines in FIG. 11B1 to FIG. 11B3. Vertical axes of the broken lines are illustrated on the right side. No difference between the intensities is indicated by “1” on the vertical axis, and a larger numerical value indicates a larger difference.

### (2) Multiple Reflection Off the Light Attenuation Member 40 and the Light Receiving Sensors 13b, 14b, and 15b Will be Described Below.

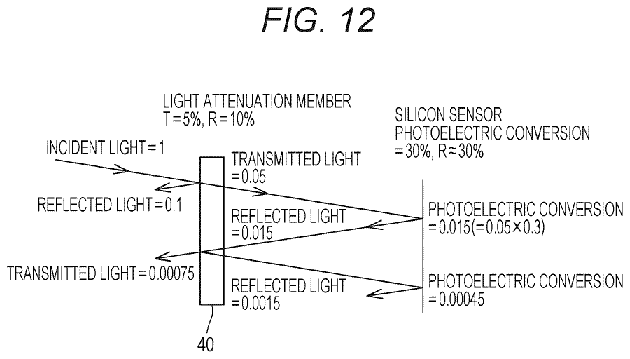

FIG. 12 illustrates transmission, reflection, and reception of the light 2 to be measured with respect to the light attenuation member 40 and the light receiving sensors 13b, 14b, and 15b. It is assumed that the transmittance T and the reflectance R of the light attenuation member 40 arc T=5% and R=10%, respectively, and the photoelectric conversion rate and the reflectance R of the light receiving sensors (silicon sensors) 13b, 14b, and 15b are photoelectric conversion rate≈30% and R≈30%, respectively.

When the intensity of incident light is defined as 1, the intensity of transmitted light that has passed through the light attenuation member 40 is 0.05 and the intensity of reflected light is 0.10.

The transmitted light that has an intensity of 0.05 and has been transmitted through the light attenuation member 40 reaches each of the light receiving sensors 13b, 14b, and 15b, and is received and photoelectrically converted by each of the light receiving sensors 13b, 14b, and 15b. The intensity of the photoelectrically converted light is 0.015 (=0.05×0.3). A part of the light that has reached the light receiving sensors 13b, 14b, and 15b is reflected off the light receiving sensors 13b, 14b, and 15b. The intensity of the reflected light is 0.015 (=0.05×0.3).

The reflected light that has an intensity of 0.015 and has been reflected off the light receiving sensors 13b, 14b, and 15b returns to the light attenuation member 40, but a part of the reflected light is reflected again off the light attenuation member 40 and travels to the light receiving sensors 13b, 14b, and 15b, and a part of the reflected light is transmitted through the light attenuation member 40 and returns toward the splitting optical system 12. The intensity of the light that is reflected again and travels to the light receiving sensors 13b, 14b, and 15b is 0.0015 (=0.015×0.1). The intensity of the light transmitted through the light attenuation member 40 and returning toward the splitting optical system 12 is 0.00075 (=0.015×0.05).

A part of the reflected light which has an intensity of 0.0015 and has traveled again to the light receiving sensors 13b, 14b, and 15b is received and photoelectrically converted by the light receiving sensors 13b, 14b, and 15b. The intensity of the photoelectrically converted light is 0.00045 (=0.0015×0.3). Although a part of the reflected light having an intensity of 0.0015 is reflected off the light receiving sensors 13b, 14b, and 15b, the subsequent multiple reflection is ignored.

According to the behavior of the light to be measured described above, the total intensity of the light that is to be measured and has been photoelectrically converted by the light receiving sensors 13b, 14b, and 15b is 0.01545 (=0.015+0.00045).

### (3) The Effect of Multiple Reflection Off the Light Attenuation Member 40, the Color Filters 13a, 14a, and 15a, and the Light Receiving Sensors 13b, 14b, and 15b Will be Described Below.

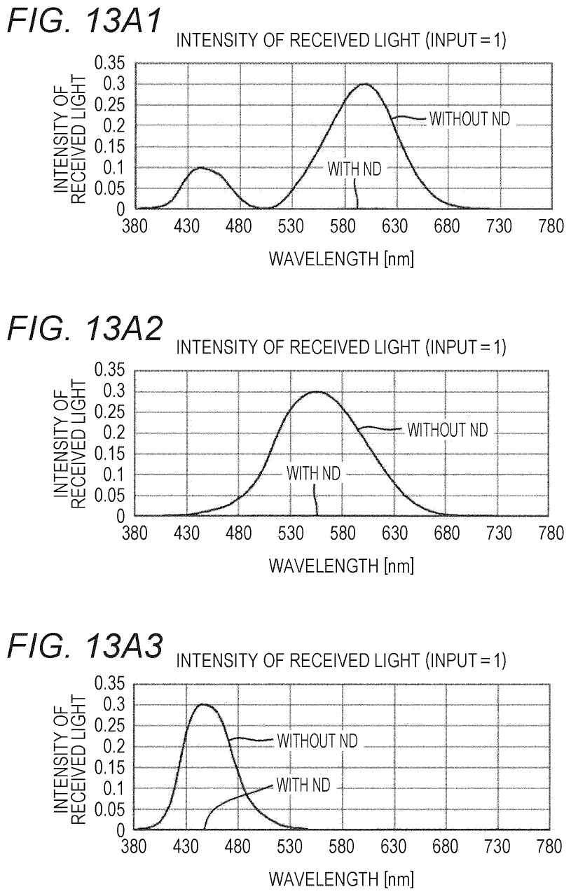

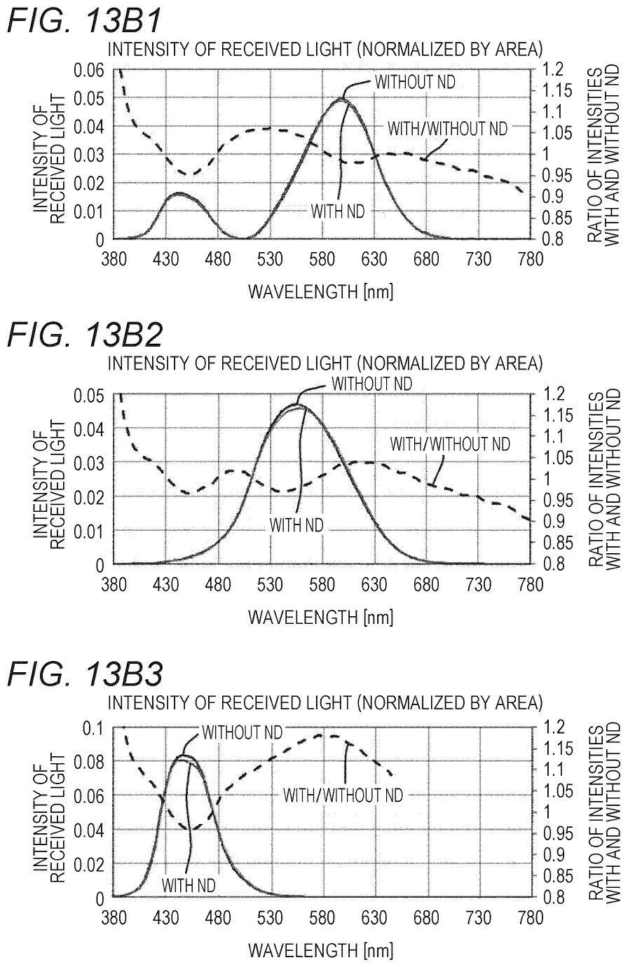

Next, the total intensity of light in the range of wavelengths from 380 to 780 nm was calculated for each of the X filter 13a, the Y filter 14a, and the Z filter 15a in each of the state in which the light attenuation member 40 was inserted in the light path and the state in which the light attenuation member 40 was removed from the light path. The total intensity of the light is a total intensity of photoelectrically converted light which is the light 2 that is to be measured, has the intensity 1, enters the color filters 13a, 14a, and 15a, and is photoelectrically converted by the light receiving sensors 13b, 14b, and 15b. The results are illustrated in FIGS. 13A1 to 13A3.

Each of curves indicated by “without ND” indicates the intensity (light of received light) of the photoelectrically converted light in the state in which the light attenuation member 40 is removed from the light path. The intensity of the received light is the intensity of light which is the light 2 that is to be measured, has the intensity 1, and is input to each of the color filters 13a, 14a, and 15a, transmitted through the color filters 13a, 14a, and 15a, received and photoelectrically converted by each of the light receiving sensors 13b, 14b, and 15b. Each of curves indicated by “with ND” indicates the intensity of received light in the state in which the light attenuation member 40 is inserted in the light path. The intensity of the received light is the intensity of light (including light received again due to reflection) which is the light 2 that is to be measured, has the intensity 1, and is input to each of the color filters 13a, 14a, and 15a, transmitted through the light attenuation member 40, and received and photoelectrically converted by each of the light receiving sensors 13b, 14b, and 15b.

FIGS. 13B1 to 13B3 are graphs in which the characteristics illustrated in FIGS. 13A1 to 13A3 are normalized by areas in order to make the evaluation criteria the same. In each of the graphs, there is a slight difference in intensity of received light intensity between the state in which the light attenuation member 40 is inserted in the light path and the state in which the light attenuation member 40 is not inserted in the light path.

In order to clarify the difference in intensity of received light between the state in which the light attenuation member 40 is inserted in the light path and the state in which the light attenuation member 40 is not inserted in the light path, results of calculating the ratios of the intensities of received light indicated by “with ND” to the intensities of received light indicated by “without ND” are indicated by broken lines in FIG. 13B1 to FIG. 13B3. Vertical axes of the broken lines are illustrated on the right side. No difference between the intensities is indicated by “1” on the vertical axis, and a larger numerical value indicates a larger difference.

It is considered that such a difference in intensity of received light represents the effect of multiple reflection off the color filters 13a, 14a, and 15a, the light attenuation member 40, and the light receiving sensors 13b, 14b, and 15b.

To be more specific, when the light attenuation member 40 is designed to match the color-matching functions in a state in which the light attenuation member 40 is removed from the light path, the received light spectral sensitivity changes due to multiple reflection off the color filters 13a, 14a, and 15a, the light attenuation member 40, and the light receiving sensors 13b, 14b, and 15b, which occurs when the light attenuation member 40 is inserted in the light path. That is, since the received light spectral sensitivity deviates from the color-matching functions, it is considered that a measurement error of the luminance and chromaticity increases. The design factors of the light attenuation member 40 that match the color-matching functions include, for example, the transmittances of the objective optical system 11 and the like, the transmittances of the color filters 13a, 14a, and 15a, the sensitivities of the light receiving sensors 13b, 14b, and 15b, and other factors.

<In Case where Insertion and Removal Position of Light Attenuation Member 40 is Between Color Filters 13a, 14a, and 15a and Diffuser Plate 20>

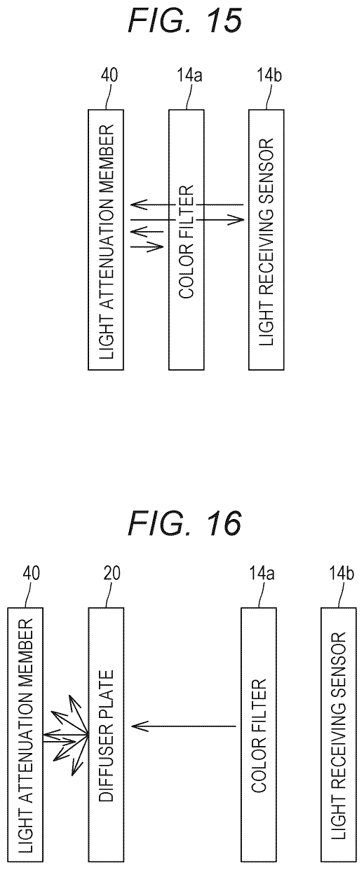

FIG. 14 illustrates a case where the insertion and removal position of the light attenuation member 40 is between the color filters 13a, 14a, and 15a and the diffuser plate 20. Also in this case, as schematically illustrated in FIG. 15, multiple reflection occurs on the light attenuation member 40 and each of the light receiving sensors 13b, 14b, and 15b and occurs on the light attenuation member 40 and each of the color filters 13a, 14a, and 15a. Therefore, similarly to the above-described case where the light attenuation member 40 is inserted and removed between the color filters 13a, 14a, and 15a and the light receiving sensors 13b, 14b, and 15b, the presence and absence of the light attenuation members 40 causes a difference in intensity of received light between the light receiving sensors 13b, 14b, and 15b. It is predicted that this difference affects an increase in a measurement error.

<In Case where Insertion and Removal Position of Light Attenuation Member 40 is in Front of Splitting Optical System 12>

Next, the reason why a measurement error is suppressed in a case where the insertion and removal position of the light attenuation member 40 is in front of the diffuser plate 20 that is the splitting optical system 12, as in the first embodiment illustrated in FIG. 1, will be described.

Also in this case, in the state in which the light attenuation member 40 is inserted in the light path, the light reflected from the color filters 13a, 14a, and 15a and the light reflected from the light receiving sensors 13b, 14b, and 15b return to the diffuser plate 20, pass through the diffuser plate 20, and return to the light attenuation member 40.

However, as illustrated in the schematic diagram of FIG. 16, the light having returned to the diffuser plate 20 is diffused by and transmitted through by the diffuser plate 20 (the angle is expanded), and therefore, the intensity of the light returning straight (at an angle of 0 degrees) to the light attenuation member 40 decreases. Therefore, the intensity of the light that is reflected again off the light attenuation member 40 and travels again to the color filters 13a, 14a, and 15a and the light receiving sensors 13b, 14b, and 15b decreases.

That is, since the effect of the multiple reflection on the intensities of the light received by the light receiving sensors 13b, 14b, and 15b becomes small, a ratio at which the received light spectral sensitivity deviates from the color-matching functions becomes small, and it is possible to suppress a measurement error of the luminance and the chromaticity.

When the brightness of the object 1 to be measured is equal to or less than a predetermined value, measurement is performed in the state in which the light attenuation member 40 is removed from the light path of the light 2 to be measured, and the light attenuation member 40 is not present in the light path in the photometric apparatus 10 illustrated in FIG. 1.

On the other hand, when the brightness of the object 1 to be measured exceeds the predetermined value, the measurement is performed in the state in which the light attenuation member 40 is inserted in the light path of the light 2 to be measured and is interposed. The interposition of the light attenuation member 40 expands the dynamic range of the photometric apparatus 10. In addition, since the light attenuation member 40 is inserted in front of the diffuser plate 20, a measurement error is suppressed. As a result, a highly functional photometric apparatus 10 capable of performing measurement with high accuracy in a wide dynamic range is obtained.

### Second Embodiment

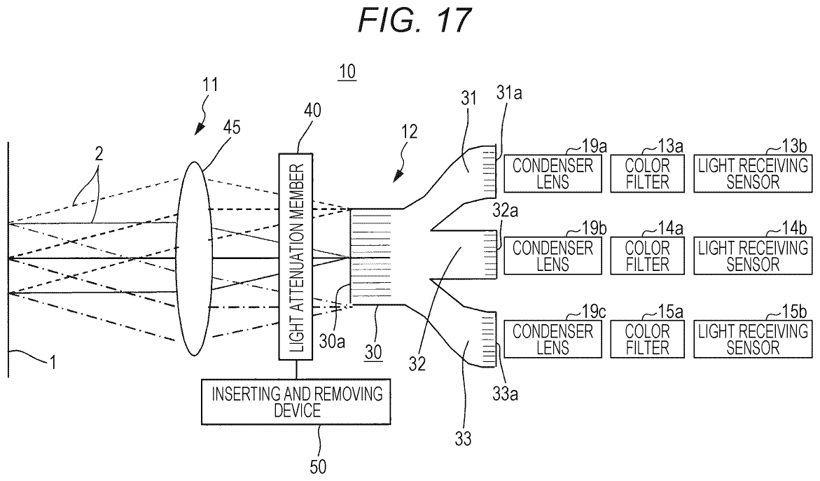

In a second embodiment, as illustrated in FIG. 17, a bundle fiber 30 is used in place of the diffuser plate 20 as the splitting optical system 12 in the first embodiment. No aperture diaphragm 11b is provided. Note that the aperture diaphragm 11b may be provided. In addition, condenser lenses 19a, 19b, and 19c are disposed between emission ends of the bundle fiber 30 and the respective color filters.

Since other configurations, such as the light attenuation member 40, the insertion and removal device 50, the color filters 13a, 14a, and 15a, the light receiving sensors 13b, 14b, and 15b, the electrical processing units 16a to 16c, and the controller 17, are the same as those described in the first embodiment illustrated in FIG. 1, the same reference signs are given and a description thereof is omitted. Provided that an illustration of the electrical processing sections 16a, 16b, 16c and the controller 17 is omitted in FIG. 17.

The bundle fiber 30 is formed by bundling a plurality n (n=several hundred to several thousand) of strand fibers having a small diameter (φ=about 0.03 to 0.3 mm) on the entrance side. On the exit side of the bundle fiber 30, the plurality n of strand fibers are randomly branched into a plurality (three corresponding to the tristimulus values of X, Y, and Z in this embodiment) of pieces, and the pieces are bundled in groups of a plurality m of pieces. Reference signs 31, 32, and 33 indicate branch portions. The shapes of an incident end 30a and the emission ends 31a, 32a, and 33a of the respective branch portions 31, 32, and 33 are arbitrary (circular, rectangular, or the like).

In the photometric apparatus 10 illustrated in FIG. 17, the light 2 that is to be measured from the object 1 to be measured and has passed through the objective optical system 11 passes through the light attenuation member 40 or directly enters the incident end 30a of the bundle fiber 30. The incident light to be measured is transmitted through the bundle fiber 30 and emitted from each of the emission ends 31a, 32a, and 33a of the three branch portions 31, 32, and 33.

The emitted light to be measured is incident on the condenser lenses 19a, 19b, and 19c, travels to the color filters 13a, 14a, and 15a, and further to the light receiving sensors 13b, 14b, and 15b, and is received by the light receiving sensors 13b, 14b, and 15b.

Also in the second embodiment, in the state in which the light attenuation member 40 is inserted in the light path, as in the first embodiment, the light 2 that is to be measured and has passed through the bundle fiber 30 travels from the condenser lenses 19a, 19b, and 19c to the color filters 13a, 14a, and 15a and further to the light receiving sensors 13b, 14b, and 15b. A part of the light 2 that is to be measured and has traveled to the light receiving sensors 13b, 14b, and 15b is reflected off the color filters 13a, 14a, and 15a and the light receiving sensors 13b, 14b, and 15b.

Then, the reflected light returns to the bundle fiber 30, passes through the bundle fiber 30, and returns to the light attenuation member 40.

However, in a case where the bundle fiber 40 has a certain length or more, the reflection angles are randomized (mixed). Therefore, similarly to the diffuser plate 20, the light emitted from the incident end 30a of the bundle fiber 30 to the light attenuation member 40 is diffused, and the intensity of the light returning to the light attenuation member 40 in a straight line (at an angle of 0 degrees) decreases. Therefore, the intensity of the light that is reflected again off the light attenuation member 40 and travels again to the color filters 13a, 14a, and 15a and the light receiving sensors 13b, 14b, and 15b decreases.

That is, the same effect as that of the diffuser plate 20 is also obtained in the bundle fiber 30, and the effect of the multiple reflection on the intensity of the light received by the light receiving sensors 13b, 14b, and 15b decreases. Therefore, a ratio at which the received light spectral sensitivity deviates from the color-matching functions becomes small, and a measurement error of the luminance and the chromaticity is suppressed.

Here, the mixing effect of the bundle fiber 30 will be described.

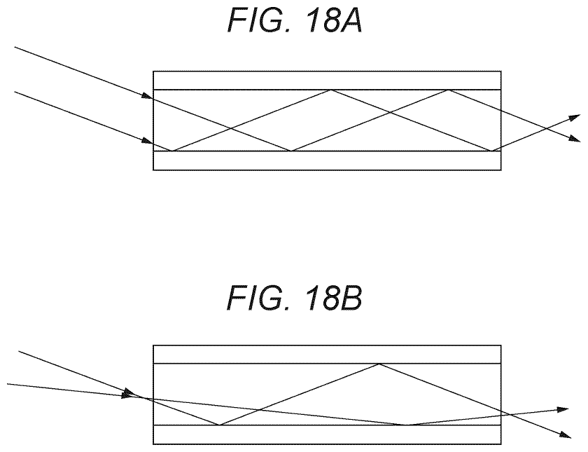

Ideally, as illustrated in FIGS. 18A and 18B, an optical fiber guides incident light by totally reflecting the incident light using a difference in refractive index between a core and a cladding of the optical fiber. However, in actual, the emission position and the emission angle become random due to a local difference (striae) in refractive index, a local difference (thick or thin) in fiber diameter, or curvature of the reflecting surface or distortion of the material (refractive index) caused by bending of the fiber. Therefore, the incident light is not transmitted in such an ideal form, and the emitted light is uniformized (the emission position and the emission angle are randomized).

That is, in a case where an optical fiber which is long to some extent is used, emitted light is made uniform and is always emitted under a stable emitting angle condition without depending on the characteristics of the light incident on the optical fiber. That is, it has the same effect as the diffuser plate 20. A greater amount of light is obtained than that in a case where the diffuser plate 20 is used. Such a characteristic of the optical fiber is utilized in the photometric apparatus 10 according to the second embodiment.

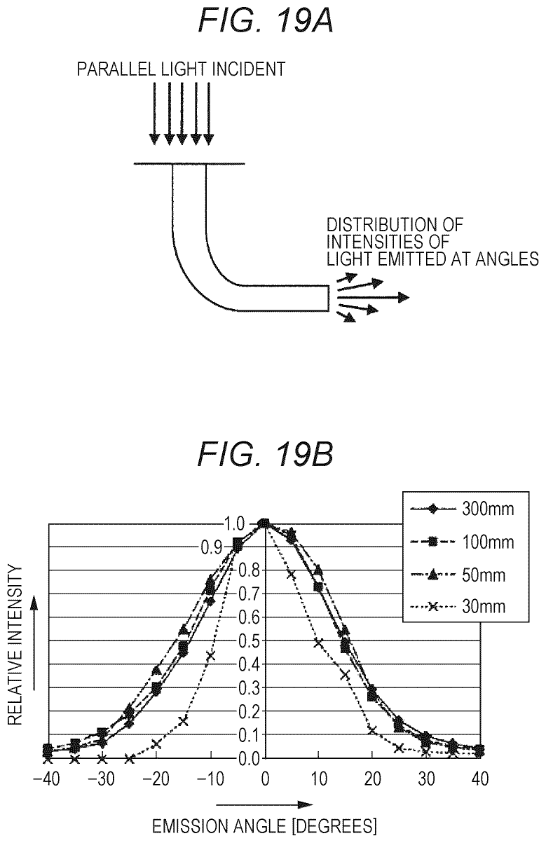

FIG. 19A and FIG. 19B illustrate experimental results. FIG. 19B is a graph illustrating actual measured data of emission angles of optical fibers. In this experiment, as illustrated in FIG. 19A, substantially parallel light (light flux at angles of ±2 degrees or less) was incident on the optical fibers, and measurement was performed by a luminance meter (not illustrated) facing the emission ends of the optical fibers. Each of the fibers is bent by 90° at one point. Furthermore, each of the fibers is a plastic fiber (NA=0.5, φ=1 mm), and lengths of the fibers are set to 30 mm (x), 50 mm (▴), 100 mm (▪), and 300 mm (♦).

In a case where the parallel light is incident, from FIG. 19B, the effective angular aperture (the breadth of the 5% intensity of the peak) of the fiber having a length of 50 mm is about ±35°. Even in a case where the fiber has a length of 50 mm or more, the angular aperture hardly changes and is stable. On the other hand, in a case where the fiber has a length of 30 mm, the intensity distribution of the emitted light becomes narrow, and the degree of mixing (uniformization) is low.

The mixing can be sufficiently uniformly performed in the single fiber as long as the single fiber has a length of 50 mm or more. The relationship between the incident light, the emitted light, and the length of the fiber depends on the number of times of reflection off the core and the cladding of the fiber when the light is guided through the fiber. Therefore, it is desirable that the length of the fiber be equal to or more than 50 times the diameter of the fiber because a length required for a diameter=1 mm is 50 mm. By using the optical fiber having such a length, the emission angle is made uniform (the emission angle does not have unique information), and a stable emission angle condition is always obtained.

As described above, by making the fiber length of the single fiber sufficiently long, it is necessary to randomly mix light having different incident angles while the light passes through the inside of the fiber. In addition, the information of the light needs to be converted into uniform information with a spread defined by the numerical aperture (NA). The sufficient length of the optical fiber that can cancel information of an angle at which light is incident on the optical fiber is 50 times or more the diameter of the core of the optical fiber as described above.

For example, in a case where the diameter φ of each strand of the bundle fiber 30 is 0.03 mm, it is preferable that the length of the bundle fiber 30 be 1.5 mm or more. In a case where the diameter q of each strand of the bundle fiber 30 is 0.3 mm, it is preferable that the length of the bundle fiber 30 be 15 mm or more.

### Third Embodiment

In a third embodiment, a finder optical system for a measurer to visually recognize the periphery of an area to be measured is provided.

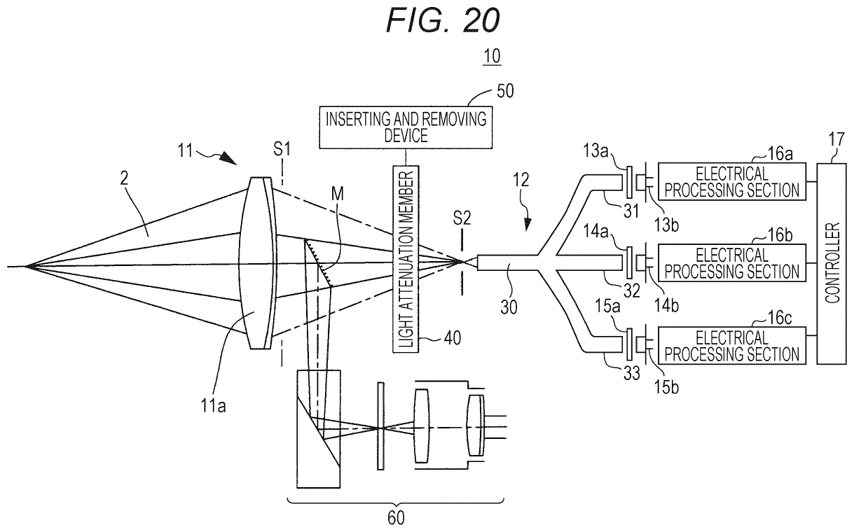

That is, as illustrated in FIG. 20, a mirror M that bends a part of the light path of the light 2 to be measured is disposed between the objective optical system 11 and the incident end of the splitting optical system 12 (the bundle fiber 30). Then, a light flux not reflected off the mirror M is guided to the splitting optical system 12 and the light receiving sensors 13b, 14b, and 15b, and measurement of luminance, color, and the like is performed. On the other hand, light reflected off the mirror M is guided to the finder optical system 60, so that the measurer can visually recognize the periphery of the area to be measured. In FIG. 20, reference signs S1 and S2 are slits.

In a case where the light attenuation member 40 is arranged in front of the mirror M, the light attenuation member 40 is inserted or removed in accordance with the brightness of the object 1 to be measured, and thus it is difficult to visually recognize the light attenuation member 40. For this reason, it is preferable that the light attenuation member 40 be disposed behind the mirror M.

Since the configurations other than the finder optical system 60, the mirror M, and the slits S1 and S2 are the same as those described in the second embodiment, a description thereof will be omitted. Further, in FIG. 20, the condenser lenses 19a, 19b, and 19c behind the bundle fiber 30 are omitted. Furthermore, the diffuser plate 20 may be used instead of the bundle fiber 30.

### Fourth Embodiment

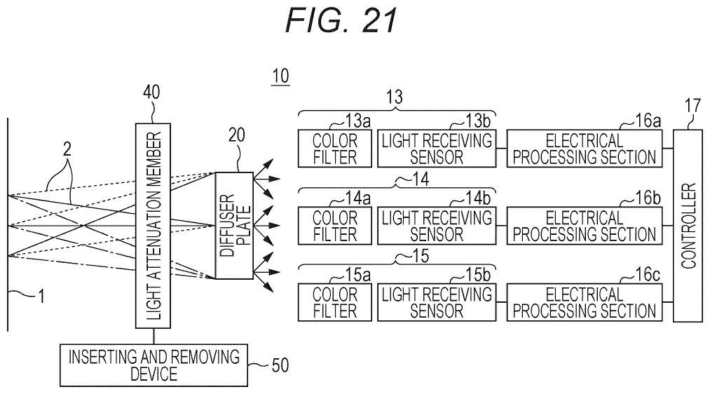

In a fourth embodiment, as illustrated in FIG. 21, the convex lens 11a and the aperture diaphragm 11b that are the objective optical system 11 are omitted in the photometric apparatus 10 according to the first embodiment illustrated in FIG. 1. Therefore, the light 2 to be measured from the object 1 to be measured directly enters the light attenuation member 40.

The configurations other than the objective optical system 11 are the same as those in the photometric apparatus 10 illustrated in FIG. 1, and thus a description thereof will be omitted. Note that the bundle fiber 30 may be used instead of the diffuser plate 20.

### Fifth Embodiment

In a fifth embodiment, in the photometric apparatus 10 according to the first embodiment illustrated in FIG. 1, the configuration of the colorimetric optical system 13 is changed.

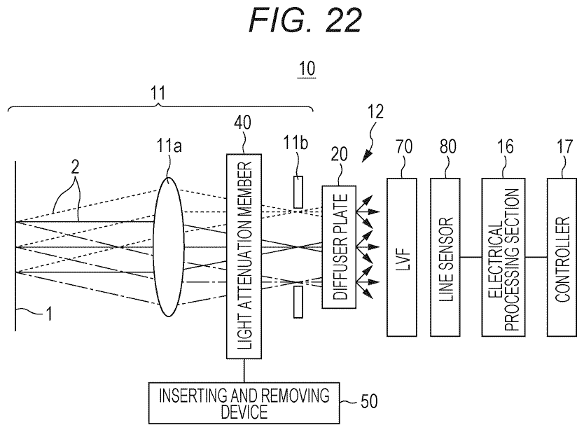

That is, as illustrated in FIG. 22, a linear variable filter (LVF) 70 which is a spectral filter capable of continuously varying wavelengths is used instead of the three color filters 13a, 14a, and 15a. A line sensor 80 is used as a light receiving sensor. However, instead of the line sensor 80, a plurality of light receiving sensors may be arranged and used.

The configurations other than the colorimetric optical systems 13, 14, and 15 are the same as those in the photometric apparatus 10 illustrated in FIG. 1, and thus a description thereof will be omitted.

Also in the photometric apparatus 10 according to the fifth embodiment, multiple reflection occurs on the light attenuation member 40, and the linear variable filter 70 and the line sensor 80. However, similarly to the photometric apparatus 10 according to the first embodiment, and the effect of the multiple reflection is suppressed by the diffusion action of the diffuser plate 20 on the return light.

Note that the bundle fiber 30 may be used instead of the diffuser plate 20.

### [Control of Insertion and Removal of Light Attenuation Member]

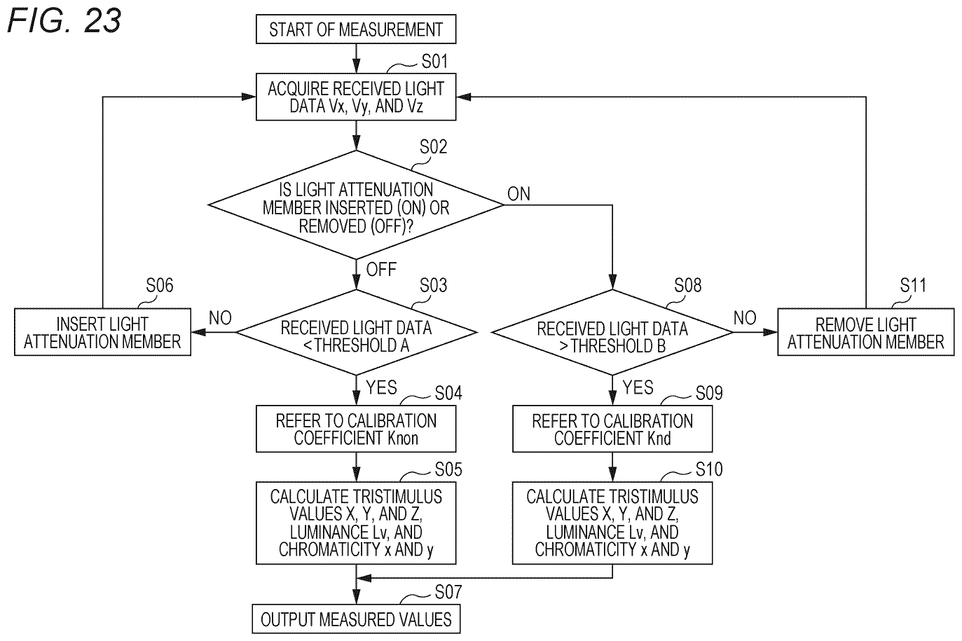

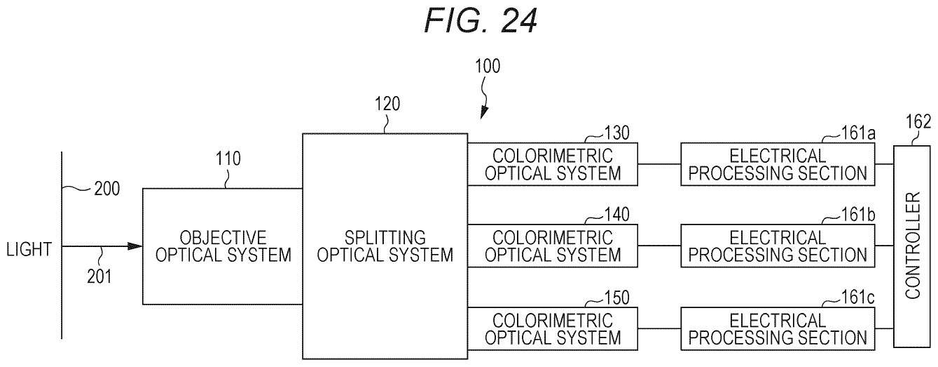

FIG. 23 is a flowchart for explaining a method of controlling the insertion and removal of the light attenuation member 40 in each photometric apparatus 10 according to the present embodiment. This control is performed by the controller 17.

After the start of measurement, the controller 17 acquires received light data V_{X}, V_{Y}, and V_{Z} in step S01. Next, in step S02, the controller 17 determines whether the light attenuation member 40 is inserted in the light path (ON) or removed from the light path (OFF).

In a case where the ND filter 40 is removed from the light path (OFF in step S02), the controller 17 checks in step S03 whether or not the received light data is smaller than a threshold A. In a case where the light received data is smaller the threshold A (YES in step S03), the controller 17 refers to the calibration coefficient knon in step S04, then calculates the tristimulus values X, Y, and Z, the luminance LV, and the chromaticity x and y in step S05, and outputs the tristimulus values X, Y, and Z, the luminance LV, and the chromaticity x and y in step S07.

In a case where the received light data is not smaller than the reference value A in step S03 (NO in step S03), the controller 17 inserts the light attenuation member 40 into the light path in step S06, and then returns to step S01 to acquire received light data again.

In a case where the light attenuation member 40 is inserted in the light path in step S02 (ON in step S02), the controller 17 determines in step S08 whether the light reception value is larger than a threshold B. In a case where the received light data is larger than the threshold B (YES in step S08), the controller 17 refers to the calibration coefficient knd in step S09, then calculates the tristimulus values X, Y, and Z, the luminance LV, and the chromaticity x and y in step S10, and outputs the tristimulus values X, Y, and Z, the luminance LV, and the chromaticity x and y in step S07.

In a case where the received light data is not larger than the threshold B in step S08 (NO in step S08), the controller 17 removes the light attenuation member 40 from the light path in step S11, and then returns to step S01 to acquire light reception data again.

### INDUSTRIAL APPLICABILITY

The present invention can be used as a photometric apparatus capable of measuring the luminance, chromaticity, and the like of light emitted from an object to be measured such as a display of a smartphone or a liquid crystal monitor.

What is claimed is:

1. A photometric apparatus comprising:
a splitting optical system that splits light to be measured from an object to be measured into a plurality of light rays;
a colorimetric optical system having a wavelength-selective filter on which the light that is to be measured and has been split by the splitting optical system is incident, and a light receiving sensor that receives the light that is to be measured and has been transmitted through the wavelength-selective filter; and
a light attenuation member that is insertable in and removable from a light path of the light to be measured, wherein
the light attenuation member is disposed in front of the splitting optical system.

2. The photometric apparatus according to claim 1, wherein the light attenuation member is inserted in and removed from the light path in accordance with brightness of the object to be measured.

3. The photometric apparatus according to claim 1, wherein the light attenuation member is formed of a thin film filter.

4. The photometric apparatus according to claim 1, wherein the light receiving sensor is a silicon sensor.

5. The photometric apparatus according to claim 1, wherein the wavelength-selective filter is a thin film filter.

6. The photometric apparatus according to claim 1, wherein the splitting optical system is a diffuser plate.

7. The photometric apparatus according to claim 1, wherein the splitting optical system is a bundle fiber.

8. The photometric apparatus according to claim 7, wherein a length of the bundle fiber is equal to or more than 50 times a diameter of a core of a strand.

9. The photometric apparatus according to claim 1, further comprising a mirror that guides the light to be measured to an observation optical system in front of the splitting optical system, wherein the light attenuation member is disposed between the mirror and the splitting optical system.

10. The photometric apparatus according to claim 1, wherein the wavelength-selective filter is a color-matching function filter.

11. The photometric apparatus according to claim 1, wherein the wavelength-selective filter is a spectral filter, and the light receiving sensor is a line sensor.

12. A photometric method comprising:
inserting and removing a light attenuation member into and from a light path of light to be measured at a position in front of a splitting optical system in a photometric apparatus including
the splitting optical system that splits the light to be measured from an object to be measured into a plurality of light rays, and
a colorimetric optical system having a wavelength-selective filter on which the light that is to be measured and has been split by the splitting optical system is incident, and a light receiving sensor that receives the light that is to be measured and has been transmitted through the wavelength-selective filter.
